(19) United States
(12) Patent Application Publication
(10) Pub. No.: US 2012/0234251 A1
(43) Pub. Date: Sep. 20, 2012

(54) POOP TRANSPORTER

(76) Inventor: LESLEY J. HARLAN, Palo Alto, CA (US)

(21) Appl. No.: 13/419,866

(22) Filed: Mar. 14, 2012

Related U.S. Application Data
(60) Provisional application No. 61/452,852, filed on Mar. 15, 2011.

(51) Int. Cl. B65F 1/12; A01K 29/00; B65D 83/00; B65D 33/16; B65D 33/14

(52) U.S. Cl. 119/161; 383/67; 383/22; 221/45

(57) ABSTRACT

A receptacle for receiving containers of feces, for transport therein to a secondary receptacle such as a trash container, is provided. The receptacle includes a spring loaded opening, such that the opening may be held open without intervention of a person, and closed after receipt of a feces container therein. The opening may be opened under the influence of energy stored in the coil spring, such that the container(s) of feces therein may fall therefrom under the influence of gravity into the secondary receptacle. A pouch, formed on the exterior of the receptacle, may be configured to carry one or more containers for retrieval of feces thereinto.

### CROSS-REFERENCE TO RELATED APPLICATIONS

This application claims benefit of U.S. provisional patent application Ser. No. 61/452,852, filed Mar. 15, 2011, which is herein incorporated by reference.

### BACKGROUND OF THE INVENTION

1. Field of the Invention

The present invention relates to the field of the care and maintenance of animals. More particularly, the present invention relates to the retrieval of animal feces, in particular animal feces, by an individual with reduced contact between the individual and the feces, or between an individual and a container having the feces retrieved therein.

2. Background of the Art

A major detriment to the stewardship over animals, in particular pets such as dogs, is the disposal of their feces. Animals on a regular diet need exercise, and defecate regularly. The feces are, if left out, a health issue for humans. Animal feces attract rodents, carry disease, and are considered unsightly and unclean. As a result, most municipalities now require that animal owners remove their animals' feces from public places. Nonetheless, as animals such as dogs are social and territorial animals, as well as energetic animals, they need regular exercise which, in urban areas, occurs on sidewalks and urban open spaces, such as parks. As a result the animal owner, walker, or other steward, is faced with removing such feces while exercising the animal.

Many stewards of animals such as dogs carry plastic bags with them for this purpose. Such bags are commonly available as carriers for retail items, such as groceries, and are maintained by the owner in a convenient location, such as where the animals' leash is kept, or even a coat or jacket pocket. However, the steward of the animal will, on occasion, forget the bag or container and not realize this fact until they are some distance from their store of bags and a feces event has occurred, leaving them with the dilemma of searching for a mechanism to retrieve the feces or leaving it behind. Because many municipalities levy heavy fines for not retrieving ones' animals' feces, and the feces is a public health issue, this is not an acceptable option.

Once the owner has retrieved the feces in the bag or container, they are faced with the need to transport the container, having the odiferous feces therein, some distance to a secondary trash receptacle. During this time they, and others around them, are subject to the odors emanating from the receptacle, and with the sight of a container or bag having the feces therein, which they may find embarrassing or worse, and others may find disturbing. As a result there is a need for a mechanism to transport animal feces with reduced emanation of odors and less visual impact upon others and the owner or steward of the animal.

### BRIEF DESCRIPTION OF THE DRAWINGS

FIG. 1 is a perspective view of a transport receptacle of the present invention showing a recloseable opening to the pouch thereof in an open position;

FIG. 2 is a perspective view of the transport receptacle of the present invention showing the recloseable opening of the pouch thereof in a closed position;

FIG. 3 is a perspective view of a coil spring and tether arrangement of the present invention useful for moving the opening of the pouch of FIG. 2 to the open position of FIG. 1;

FIG. 4 is a perspective view of a clamp useful for selectively securing or releasing a pair of tether ends in a specific position with respect to the pouch of FIGS. 1 and 2;

FIG. 5 is a perspective partial view of the receptacle of FIG. 1 showing detail of the container dispenser mounted on the exterior thereof;

FIG. 6 is a perspective view of the non-opening end of the receptacle of FIG. 1 showing an additional feature of the container dispenser of FIG. 5;

FIG. 7 is a perspective view of a roll of containers which may be located within the container dispenser shown in FIGS. 5 and 6 and having an individual container pulled away from the roll;

FIG. 8 is a perspective view of the receptacle of FIG. 1, showing a detachment feature by which the pouch of the receptacle may be selectively removed from a strap;

FIG. 9 is a perspective view of the receptacle of FIG. 1 attached to an animal lead or leash;

FIG. 10 is a perspective view of the receptacle of FIG. 1 in position for the discharge of containers of feces therefrom without the need for an individual or user to make contact with the container; and

FIG. 11 is a perspective view of the receptacle as shown in FIG. 10, where a container is shown leaving the receptacle for disposal in a trash receptacle.

### SUMMARY OF THE INVENTION

There is provided a receptacle for the receipt, transport and disposal of secondary containers of animal feces, wherein the receptacle includes a pouch portion, having an opening thereto or thereof which is selectively maintained in a biased closed position and openable upon user intervention, at least one attachment portion for the attachment of the receptacle to a secondary mobile object, such as a leash useful in the ambulation of pets, and a container receptacle, integrally positioned on the exterior of the pouch portion, for the receipt and withdrawl by the user, upon need, for the recovery of animal feces therein and placement of the feces, within the container, into the pouch.

In one aspect, the opening of the pouch is biased, when in a free or unrestrained condition, in an open position such that the opening is sufficiently sized to receive a container of feces therein. In another aspect, the opening may be closed, such as by collapsing the opening using a drawstring or other closing mechanism, such that the opening may be held closed except when loading or unloading containers, and thus reduce the odors reaching an individual using the container.

In another aspect the container receptacle may include a pocket which may be closed using hook and loop fasteners, and a secondary dispensation opening, such that a container may be pulled from the dispensation opening by an individual when the need to recover animal feces occurs. In one aspect, the containers may be maintained in a series of releasable interconnected containers rolled together, and the first of such containers may be positioned, by the user, to protrude from the dispensation opening. Thus, as the user removes an individual container, by having the user pull the container, the beginning of the next container protrudes from the opening, and then when the container is removed, a next container will be present for use.

In another aspect, the receptacle includes a secondary multi-function feature, which, in one aspect is a loop shaped strap, with an open and closeable fastener located on the strap, which is located on the receptacle at a location distal from the receptacle opening, and may be used to secure a second end of the receptacle to a leash or other object. The strap and fastener provide a secondary function, in that the strap or fastener may be held by the user such that the receptacle is suspended therefrom and the opening of the receptacle is thus located below the strap and fastener, such that the closing mechanism may be released to allow the opening to open under the self bias feature, such that containers of feces placed therein will fall therefrom under gravity without user intervention. Thus by locating the receptacle over a trash receptacle and suspending it by the strap or fastener, the user may release the feces containers without the need of further contact therewith by the user.

### DESCRIPTION OF THE EMBODIMENTS

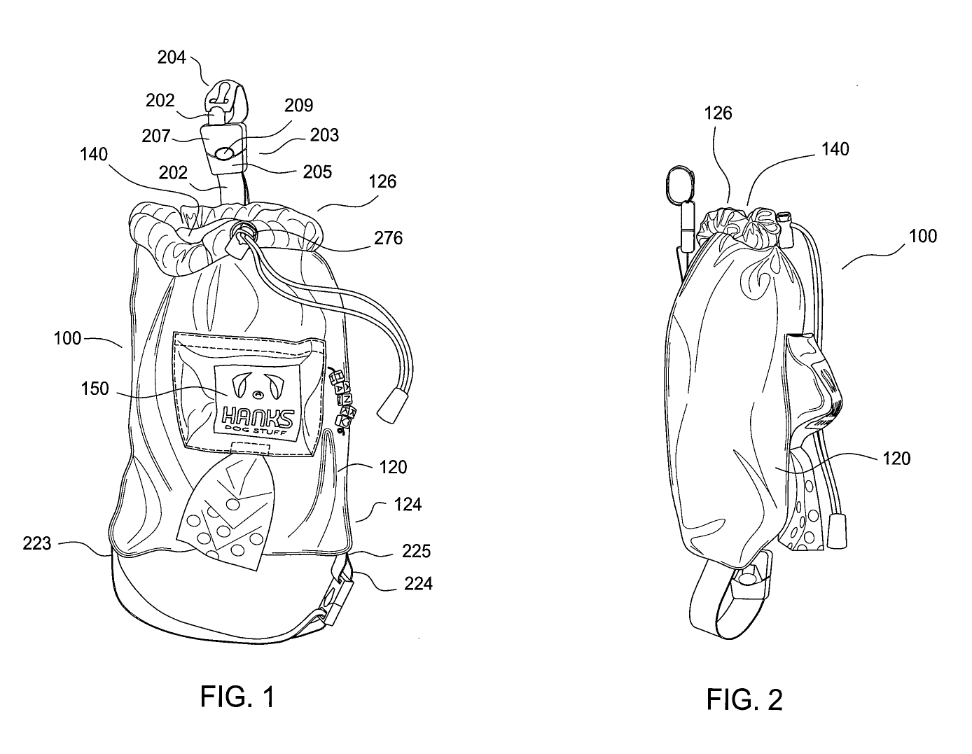

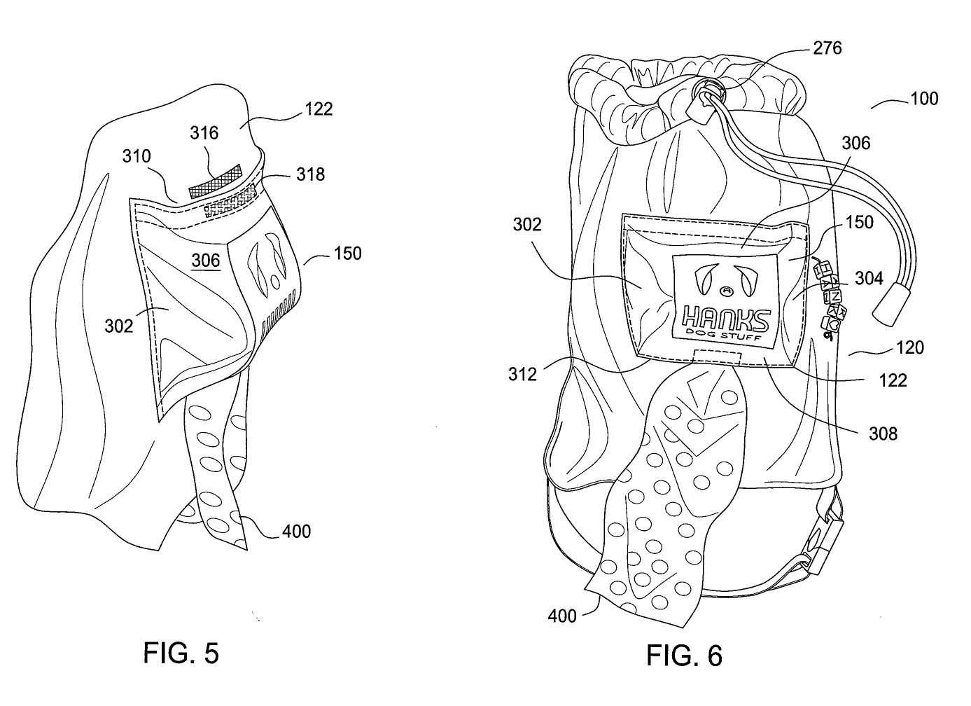

Referring to FIG. 1, there is shown an embodiment of the receptacle 100 of the present invention, having a generally cylindrical pouch 120 having an outer wall 122 brought together to form a first end 124 thereof with a single, openable and closeable, opening 140 at a second end 126 thereof. A container dispenser 150 is formed integral with, and on the outer wall 122 of the receptacle 100, for the receipt and dispensation of containers (Shown in FIGS. 5 and 6) for the recovery of animal feces therewith. The receptacle further includes at a location on outer wall 122 adjacent to, but spaced from, opening 140 an attachment mechanism 200, in this embodiment a length of strap 202 having a hook and loop fastener member 204 extending from both sides thereof, such that the strap 202 may be located over, and wrapped and secured about, an animal lead or leash 210 as shown in FIG. 9. To enable easy retrieval of the receptacle from the leash or lead on which it may be placed, the strap 202 may include a separable clip 203, which bisects the length of the strap 202 and enables the receptacle 100 to be removed from securement from the leash or lead 110 and quick reattachment thereto through the clip 203. Clip 203 has a first portion 205 connected to the portion of strap 202, a second portion 207 affixed to a second portion of strap 202, and a release mechanism 209 which, when pressed inwardly of clip 203, released portions 205, 207 from one another.

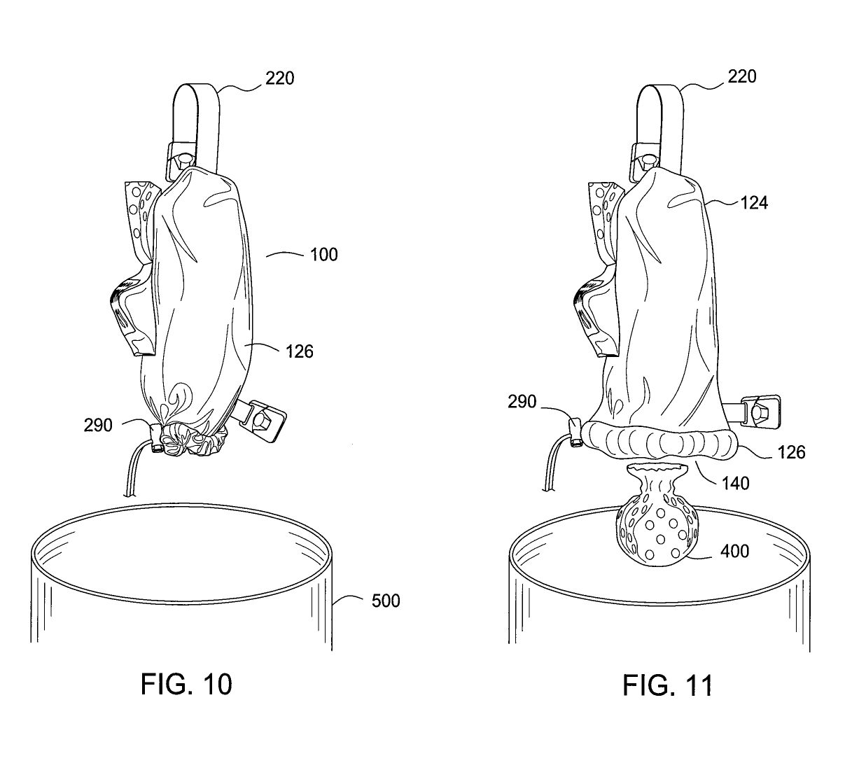

The receptacle 100 further includes a disposal holding member 220, in this embodiment a pair of straps 224, 223, extending from the lower end of the receptacle and held together at their free ends with a clip 222, having the same basic structure of the clip 203 and straps 202 discussed above. Straps 223, 224 are attached, at their opposed ends from the clip to opposed sides of the receptacle at first end 124 thereof. As will be detailed further herein, the disposal holding member 220 useful during the use of the receptacle 100 to dispose of containers 152 (FIGS. 10 and 11) having feces therein from the receptacle 100, as well as forming a second attachment member for attachment of the receptacle to the lead or leash 210. (FIG. 9) Thus, the receptacle may be attached to a leash 210 and supported therefrom from adjacent both first and second ends 124, 126 as shown in FIG. 9, which will reduce the incidence of pendulumbing of the receptacle which would occur where the first end 124 of the receptacle 100 is free to swing on the leash 210.

The receptacle 100 is, in this embodiment, formed from polyurethane coated, rip-stop nylon, a relatively thin, pliable and compliant and generally waterproof material, which may be cut into a sheet and folded and arranged to form one or more seams, the seams being sewn or otherwise closed to join together the material at the seams to form the generally tubular cylindrically shaped body 120.

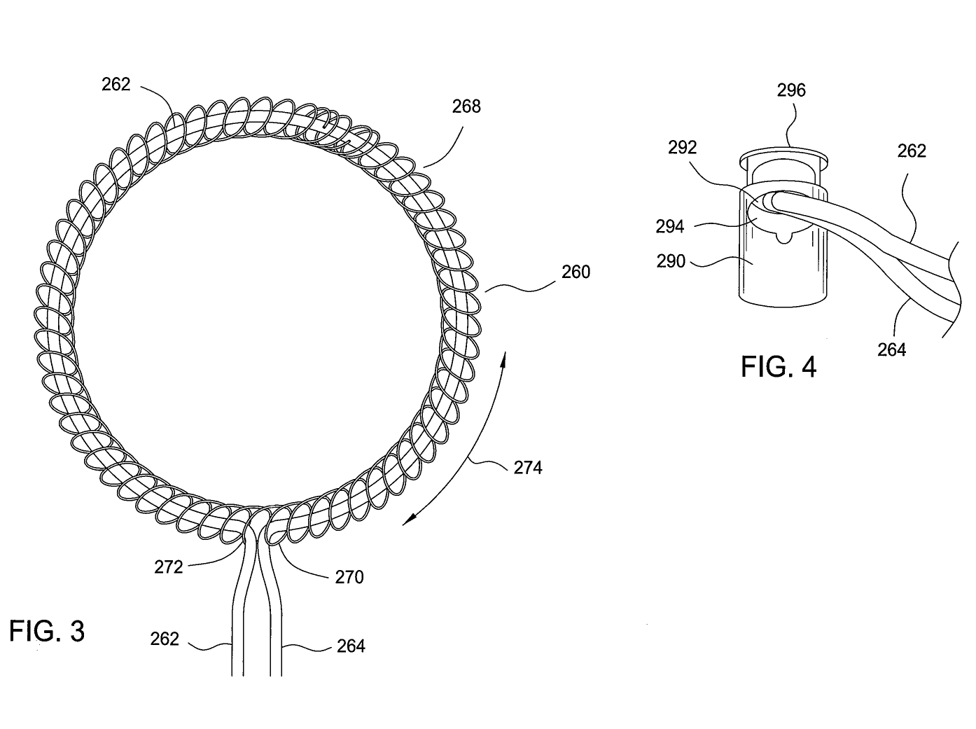

Referring to FIGS. 1 and 2, the configuration of the receptacle 100 in an open and a closed position is shown. In FIG. 2, the recloseable opening 140 at second end 126 of the pouch 120 is shown in a closed position. To form the openable and closeable feature of second end 124, a linear coil spring 260 as shown in FIG. 3, having a tether line 262 extending through the length of the spring 260 with the spring windings extending thereabout such that opposed ends 264, 266 thereof extend from the opposed ends 270, 272 of the spring 260 located within the receptacle 100 and surrounding opening 140. The coil spring 260 having tether ends 262, 264 extends from the ends thereof is configured and arranged into a loop 268 as shown in FIG. 3, such that the opposed spring ends 270, 272 abut each other and the outer circumference 274 of the looped linear coil spring 260 is larger, in its free state, that the inner circumference of the pouch 120 at second end 124 and opposite ends 264, 266 of the tether 262 extend free of the ends 270, 272 of the coil spring 260 To form the closure which enables closing and opening of the recloseable opening 140, a partially completed pouch 120 is inserted through and within the inner circumference of the looped spring 260, and the fabric adjacent to second end 124 is folded up and over the coil spring about its circumference, and sewn to the outer wall of the pouch to secure the coil spring 260 therein. Prior to the sewing, the ends 262, 264 of the tether 260 are inserted through a circular grommet 276 (FIG. 1), which is received into, and secured within, a portion of the material forming the outer wall 122 at a position adjacent to the opposed joined ends 270, 272 of coil spring 260 such that the ends 262, 264 of the tether 260 extend therefrom outwardly of the portion of the outer wall surrounding the coil spring 260. Alternatively, the open end of the uncompleted pouch 120 may be placed within the circumference of the coil spring 260, and the fabric laid over the spring and affixed to the outer surface of the outer wall 124.

Referring now to FIGS. 1 and 2, the open and closed positions of the second end 124 of the pouch 120 are shown. In FIG. 1, opening 140 in second end 126 is shown in a open position. In FIG. 2, the pouch 120 is shown with the opening 140 in the closed position, wherein the ends 264, 266 of the tether have been pulled outwardly from the grommet 276 to maintain the opening 140 in a closed position.

As shown in FIG. 4, the ends 262, 264 of the tether 260 are, in this embodiment, located through an opening 292 in a spring clamp 290 which has a closure anvil 294 which is maintained by a spring bias to pinch the ends 262, 264 of the tether 260 between the anvil 294 and the inner wall of the opening 292. By pulling on the tether ends 262, 264 while pushing the clamp release button 296 inwardly of the body of the clamp 290 to open the anvil 294 away from the wall of the hole 292 through which they extend, while simultaneously pushing the clamp 290 against the grommet 276 on the pouch (FIGS. 1 and 2), the coil spring within the second end 126 of the pouch 120 is compressed and the opening deforms from the open position of FIG. 1 to the closed position of FIG. 2. At this position the tether ends 262, 264 are further extended outwardly of the grommet 276 than when the opening is in an open position. Once the opening 126 is in the closed position of FIG. 2, that condition may be maintained by releasing the release button 296 so that it allows the anvil 294, which is spring biased to a closed or pinching condition, to move across the hole 292 to pinch the tether ends 262, 264 in place within the hole 292.

Referring now to FIGS. 1, 2, 5 and 6, the construction and arrangement of the container dispenser 150 formed on the outer wall 122 of pouch 120 is shown. In this embodiment, container dispenser 150 has a generally triangular cross section having side walls 302, 304 and an upper outer wall 306 and a lower outer wall 308 spanning the two side walls 302, 304. The container dispenser 150 is sewn, or otherwise affixed to the outer wall 122 of the pouch along the lengths of the edges of the side walls 302, 304, such that an upper gap 310 (FIG. 5) extends between the upper wall 306 and the adjacent outer wall 122, and a second, dispensing gap 312 (FIG. 6) is located between the lower wall 308 and the adjacent pouch outer wall 122 surface.

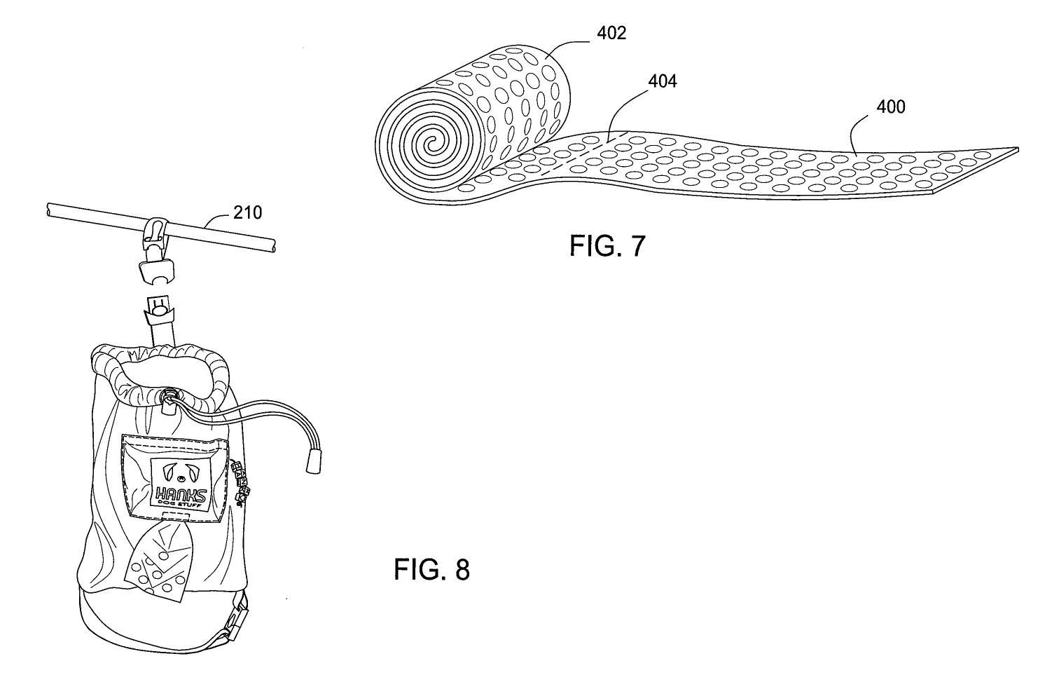

Container dispenser 150 is sized to receive containers 400 therein, and enable dispensing of containers therefrom. Although loose individual containers, such as thin plastic bags, may be individually placed within the container receptacle 150 for retrieval by the user upon the occurrence of a feces event, the receptacle 150 is particularly useful for receiving individual containers 400 which have been configured into a roll 402 form, such as shown in FIG. 7. In this aspect, individual containers, typically thin plastic or material otherwise impervious to the passage of feces material through the wall thereof while the feces is being retrieved by a user, are rolled together end to end, and may also be loosely connected by thin webs 404 which may be severed to remove the container 400 from the roll 402.

Referring again to FIGS. 5 and 6, the roll 402 may be placed into the container dispenser 150 through the upper gap 310, (FIG. 5) and the last container 400 on the roll 402 threaded through the dispensing gap 312 such that at least a portion thereof extends through the dispensing gap 312 where it may be reached by a user. To ensure that the roll 402 stays within the container dispenser, matching hook and loop fastener strips 316 and 318 (shown in phantom) are affixed to the outer wall 122 of the pouch and inner surface of the upper wall 306 of the container dispenser 150 adjacent the upper gap 310. The upper wall 306 adjacent to the upper gap is pressed against the wall 122 to close the container dispenser and maintain the roll therein, and may be pulled apart to place and maintain a further roll 402 therein as needed.

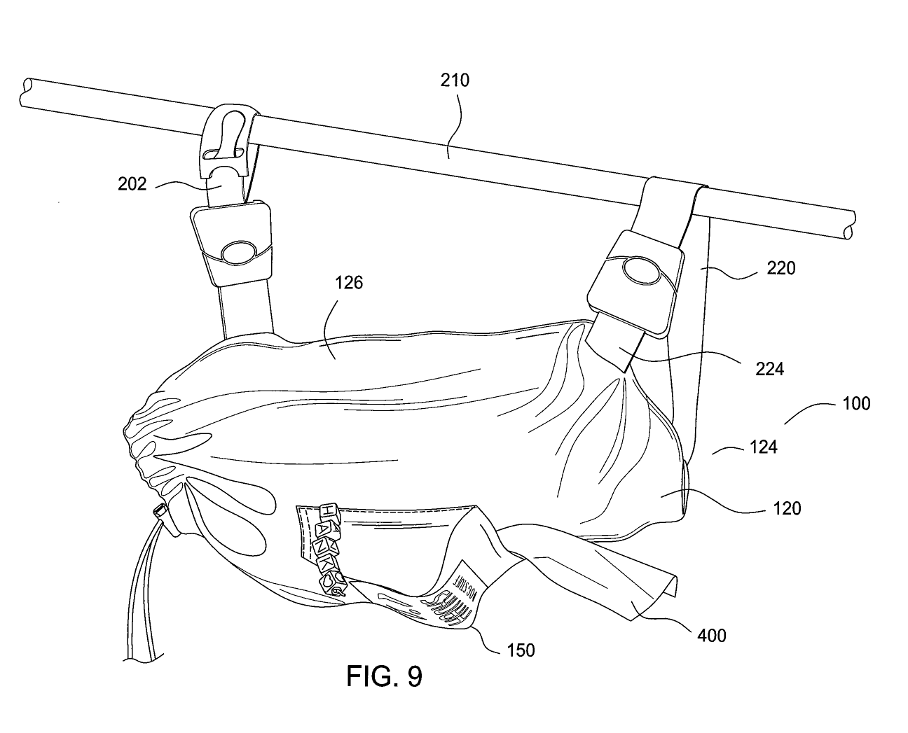

Referring now to FIGS. 8 and 9, the features of the receptacle 100 with respect to being carried independently from a user are shown. In FIG. 9, the receptacle 100 is shown suspended from a leash or lead 210. The pouch 120 of the receptacle 100 is suspended from the leash 210 by strap 202 at second end 126, and the first end 124 of the pouch 120 is also suspended from the leash by the disposal holding member 220. When a feces event occurs, the receptacle is easily retrieved or removed from the leash, by opening the clips on the disposal holding member 220 and the clip on the straps 202 and thus freeing the receptacle from the leash 210. Thus, the user can retrieve the bag for further use. Also, by attaching the receptacle to the leash 210 at both ends of the receptacle, the distance between a feces laden container within the receptacle 100, and the pivot point between the receptacle 100 and the leash 210 is shorter than if only one end of the receptacle were connected through a strap or connector to the leash 210, and thus the lateral distance which the receptacle may swing during use is reduced.

Once the receptacle is free from the leash, the user may remove a container 400 from the container dispenser 150 through dispensing slot 312, and expand the container such that the users' hand may extend through the open end thereof. The user may then retrieve the feces, and pull the open end of the bag over a hand holding the feces through the thin container wall so that the container is now inside-out and the feces has been retrieved into the container 400. The container 400 is then ready for placement into the receptacle 100. To place the container 400 into the pouch 120 of the receptacle 100, the user depresses the button 296 of clamp 290 thereby actuating the anvil 294 in a direction within hole 290 to release the pinching force pinching the ends 262, 264 of the tether 260 while holding the button 296 in a depressed state, and thereby allowing the coil spring 260 to expand and open the opening 140 adjacent to second end 126. The user then may drop the container 400 having the feces therein into the opening 140 thereby depositing the container within the pouch 120, and then, while again depressing the button, pull the tether ends 262, 264 outwardly from grommet 276 with the clamp 290 pressing against or adjacent to the grommet 276, to compress the coil spring 260 and close the opening 140 back to the position shown in FIG. 2.

Referring now to FIGS. 10 and 11, the disposal of one or more containers 400 having feces therein is shown. As shown in FIG. 10, in preparation to remove one or more containers 400 having feces therein from the receptacle 100, the receptacle is located over a secondary trash receptacle 500, such that the disposal holding member 200 may be held by a user and the pouch 120 is suspended therefrom such that second end 126, having recloseable opening 140 therein, is located below the disposal holding member 220 and the receptacle 100 is ready for the disposal of the containers of feces therein.

Then, as shown in FIG. 11, the pouch 120 opening 140 is opened, as described previously herein, by actuating the button 296 on clamp 290 to free tether ends 262, 264 from the pinch of the anvil therein, allowing the coil spring 260 (FIG. 3) to open the opening 140, which allows a container 400, having feces therein, to fall under the influence of gravity from the receptacle, into the secondary trash receptacle 500, without the need for user intervention or further touching of the feces containing containers

I claim:

1. A receptacle for the placement of containers containing recovered animal feces for later disposal, comprising:
a pouch capable of storing one or more containers and having a recloseable opening therein, the recloseable opening actuatable by a user between an open and closed position, wherein stored energy within the opening is capable of opening the recloseable opening upon a user actuation; and
a releasable strap, said strap extending from an end of said pouch opposed to the location on said pouch of said recloseable opening; and
whereby, a user, by grasping said releasable strap, may selectively actuate said recloseable opening and thereby enable said energy stored therein to open said opening, and allow any container received within said pouch to exit therefrom under the influence of gravity.

2. The receptacle of claim 1, wherein the energy capable of causing said opening to open is stored in a coil spring forming the circumference of said opening.

3. The receptacle of claim 2, wherein said coil spring has opposed ends and a plurality of windings extending between said opposed ends and forming a volume circumscribed by said coils; and
a tether extending through said volume such that opposed open ends extend outwardly from said opposed open ends of said coil spring.

4. The receptacle of claim 3, further including a clamp receiving said ends of said tether there through to selectively clamp said tether ends therein at different positions along said tether.

5. The receptacle of claim 4, wherein said tether ends extend outwardly of said receptacle adjacent to said opening and are positionable at different extension distances from said receptacle, and, said clamp is selectively operable to clamp said tether ends against movement with respect to said receptacle to enable the storage of energy in said coil spring in a state where said opening is moved toward a closed state.

6. The receptacle of claim 5, wherein said clamp is selectively positionable to allow free movement of said tether ends therethrough, and thereby free said tether ends to move and enable said coil spring to release energy stored therein to open said opening.

7. The receptacle of claim 1, further including a container dispenser thereon, said dispenser including a dispensing slot through which containers for the recovery of animal feces may be removed therefrom.

8. The receptacle of claim 1, further including a releasable attachment strap extendable from the container adjacent to said opening.

9. The receptacle of claim 9, further including a disposal holding member extending from the end of the receptacle distal to said attachment strap, said disposal holding member and said strap configured for releasable attachment to an animal lead.

10. A method of disposing of animal feces, comprising the steps of:
securing at least one container, having animal feces therein, through a recloseable opening in a receptacle;
reclosing the recloseable opening and in the act of reclosing storing energy therein;
positioning the receptacle adjacent to a secondary receptacle, while positioning the reclosable opening adjacent to the bottom or the receptacle; and
releasing the stored energy to open the recloseable opening an drelease the container into the secondary receptacle under the influence of gravity.

11. The method of disposing of animal feces of claim 10, wherein the opening includes a coil spring therein.

12. The method of disposing of animal feces of claim 11, wherein the coil spring includes a tether extending within the circumference of the coil, and opposed ends extending from the opening and received through clamp.

13. The method of claim 10, wherein the act of storing energy includes the compression of the coil spring and its securement in position by actuating the clamp to secure the tether ends.
